(19) United States
(12) Patent Application Publication
(10) Pub. No.: US 2022/0334819 A1
(43) Pub. Date: Oct. 20, 2022

(54) SOFTWARE UPGRADE VERIFICATION SYSTEM AND METHOD OF USING THE SAME

(71) Applicant: Dell Products, L.P., Round Rock, TX (US)

(72) Inventors: Chandrasekhar R, Bangalore (IN); Praveen Lalgoudar, Bangalore (IN); Raveendra Babu Madala, Bangalore (IN); Rekha MS, Karnataka (IN); Harish Babu, Bangalore (IN); Bala Balaji Gupta M, Bangalore (IN); Pandiyan Varadharajan, Bangalore (IN)

(73) Assignee: Dell Products, L.P., Round Rock, TX (US)

(21) Appl. No.: 17/234,902

(22) Filed: Apr. 20, 2021

(51) Int. Cl. G06F 8/65; G06F 9/445; G06F 8/71; G06F 8/61

(52) U.S. Cl. CPC G06F 8/65; G06F 9/44505; G06F 8/71; G06F 8/61

(57) ABSTRACT

Embodiments of systems and methods for verification of software packages prior to deployment on an Information Handling System (IHS) are described. In an illustrative, non-limiting embodiment, an IHS may include computer-executable instructions for identifying a configuration characteristic of at least one resource of a client IHS that a software package depends upon to operate on the client IHS, and updating a data structure to indicate the identified software package dependency to the configuration characteristic. When the client IHS requests to be upgraded with the software package, the instructions access the data structure to determine whether or not the configuration characteristic meets the identified software package dependency, allows or inhibits the software upgrade based on if the configuration characteristic meets the identified software package dependency.

### FIELD

The present disclosure relates generally to Information Handling Systems (IHSs), and more particularly, to a software upgrade verification system and method of using the same.

### BACKGROUND

Communication networks, and in particular the Internet, has revolutionized the manner in which software is updated on a computer system. Prior to the advent of the Internet, a software provider would package the update on computer readable media, and the computer owner had to obtain a copy of the media to complete the update in order to make the software update accessible to the user of the computer system. However, distributing software updates on computer readable media was often expensive for software providers, which tended to restrict the number of software updates that a software provider would issue. As a consequence, substantial time would pass between updates, and consumers had to manage certain known issues for these time periods, at least until an update became available. Another aspect of this older method was that many modifications were packaged into a single update to reduce the costs associated with distributing the update.

Nowadays, software updates are typically made available on one or more download sites as soon as the software provider can produce them. In this manner, software providers can be more responsive to critical flaws, security concerns, and general customer needs. As a result, to update software, a customer would query an update site for software updates, and download and install the software update if available. For example, a typical network-based software update procedure may include the steps of issuing a request over a network to a software provider's download site (e.g., update source) for a software update applicable to the client computer. The update source responds to the client computer with the software update requested by the client computer in the update request. After the client computer has received the software update, the client computer installs the received software update.

One benefit of updating software in such a manner is the reduced cost associated with producing and distributing software updates. Additionally, software updates can now be performed more frequently, especially those that address critical issues and security. Still further, a computer user has greater control as to when and which software updates should be installed on the client computer. The inventors of the present case, nevertheless, have discovered that certain software updates may incur dependencies on other resources of the computer system that can limit their ability to function satisfactorily. It is with these concerns in mind, among others, that embodiments of the present disclosure have been developed.

### SUMMARY

Embodiments of systems and methods for verification of software packages prior to deployment on an Information Handling System (IHS) are described. In an illustrative, non-limiting embodiment, an IHS may include computer-executable instructions for identifying a configuration characteristic of at least one resource of a client IHS that a software package depends upon to operate on the client IHS, and updating a data structure to indicate the identified software package dependency to the configuration characteristic. When the client IHS requests to be upgraded with the software package, the instructions access the data structure to determine whether or not the configuration characteristic meets the identified software package dependency, allows or inhibits the software upgrade based on if the configuration characteristic meets the identified software package dependency.

According to another embodiment, a method includes the steps of identifying a configuration characteristic of at least one resource of a client IHS that a software package depends upon to operate on the client IHS, and updating a data structure to indicate the identified software package dependency to the configuration characteristic. When the client IHS requests to be upgraded with the software package, the steps further include accessing the data structure to determine whether or not the configuration characteristic meets the identified software package dependency, and allowing or inhibiting the software upgrade based on if the configuration characteristic meets the identified software package dependency.

According to yet another embodiment, a memory storage device having program instructions stored thereon for identifying a configuration characteristic of at least one resource of a client IHS that a software package depends upon to operate on the client IHS, and updating a data structure to indicate the identified software package dependency to the configuration characteristic. When the client IHS requests to be upgraded with the software package, the steps further include accessing the data structure to determine whether or not the configuration characteristic meets the identified software package dependency, and allowing or inhibiting the software upgrade based on if the configuration characteristic meets the identified software package dependency.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example software update verification system according to one embodiment of the present disclosure.

FIG. 2 is a block diagram illustrating components of example IHS configured to manage a communication link with a wireless docking station according to one embodiment of the present disclosure.

FIG. 3 is a block diagram illustrating several components of the server IHS according to one aspect of the present disclosure.

FIG. 4 illustrates a package catalog updating method depicting how the package catalog of each software package may be updated according to one embodiment of the present disclosure.

FIG. 5 illustrates a software package deployment method depicting how a software package may be deployed or installed on the client IHS according to one embodiment of the present disclosure.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. It should be appreciated that although certain embodiments described herein may be discussed in the context of a personal computing device, other embodiments may utilize various other types of IHSs.

IHSs are usually configured in a certain way to meet the organization security policies and to serve specific workload requirements. System administrators are often required to apply updates to fix/address certain issues and/or to add features. Nevertheless, specific configurations or settings might prevent either software updates from getting applied or the components deviating from the organizational policy. For example, if a user of an IHS performs a particular cryptography configuration in which the SCHANNEL TLS 1.0/1.1 settings in the operating system (OS) registry are enabled, and that these SCHANNEL setting are configured with the ability to generate certificates with ciphers, an ensuing software update may fail if those ciphered certificates are not available. Similarly, certain administrators often disable USB-NIC interfaces due to organizational policy. However, this configuration setting can cause certain update failures and/or make the system unmanageable via certain methods. These problems are exacerbated by the fact that users are not aware of these limitations. The absence of such information prior to applying an update can cause severe disruptions in the functionality of the IHS.

Conventional software update systems are fraught with many problems. For example, providing necessary dependency information as described above prior to applying each software update may possess certain challenges, such as the ability to comprehend all possible failures prior to publishing update packages, and the ability to decipher the resolution techniques to overcome the possible update failures, among others. As will be described in detail herein below, embodiments of the present disclosure provide a system for verifying software update deployment readiness prior to the update so that the user can assess the impact to their IHS's operating environment.

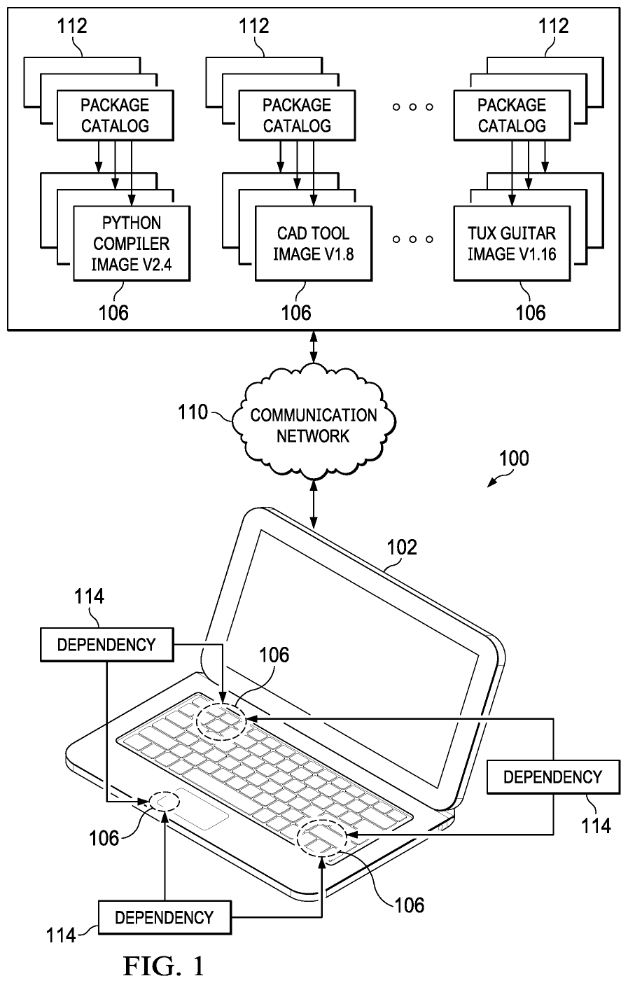

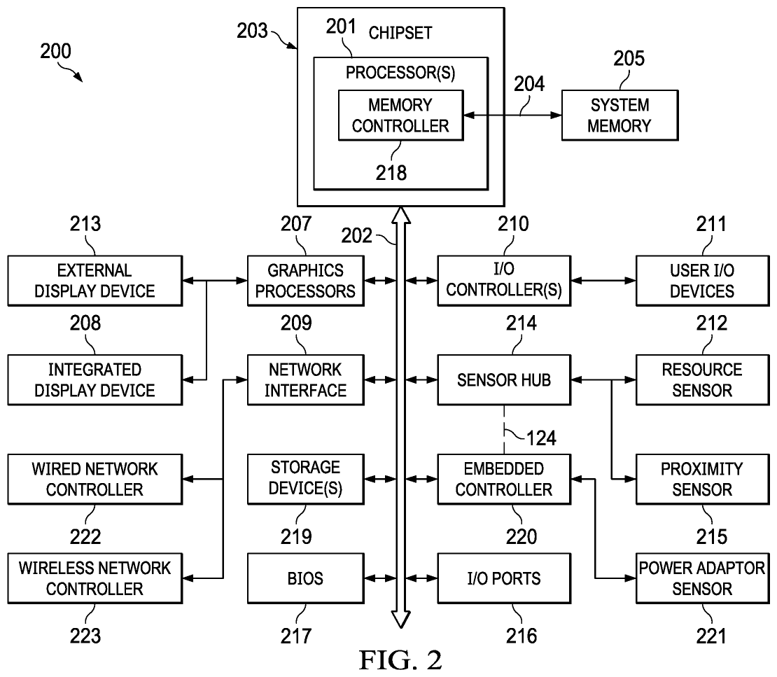

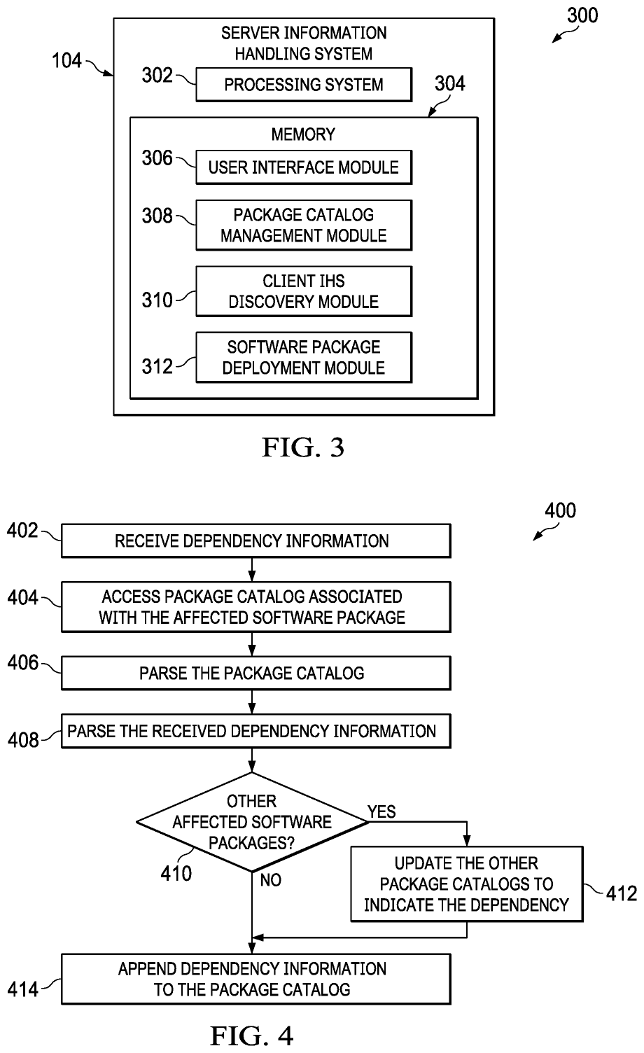

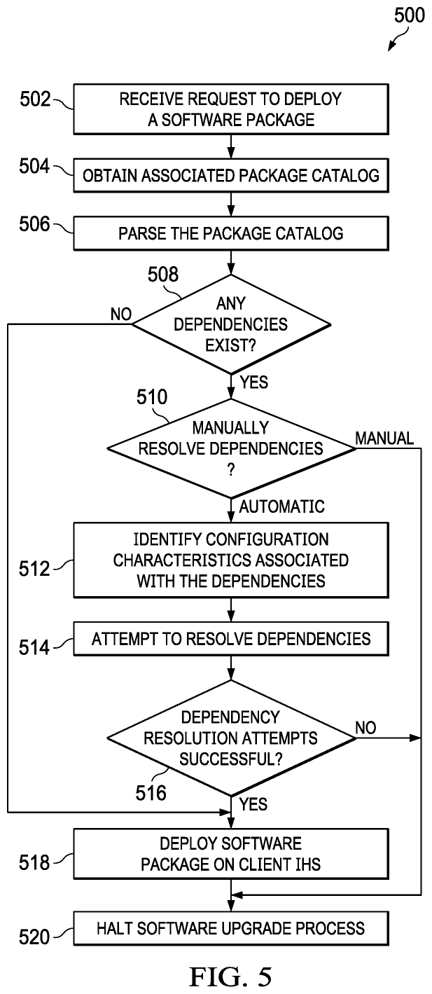

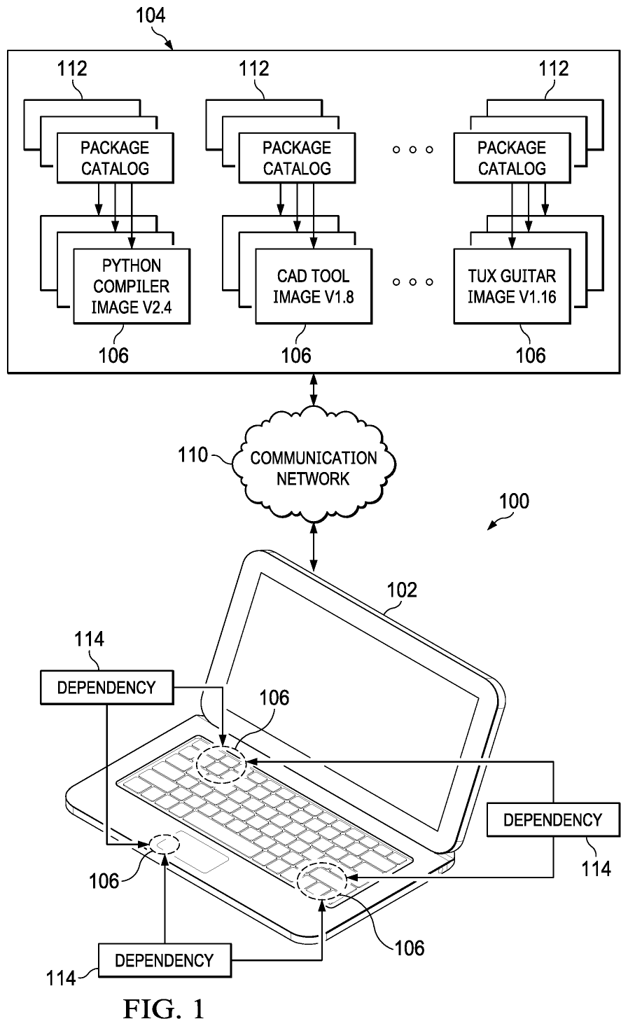

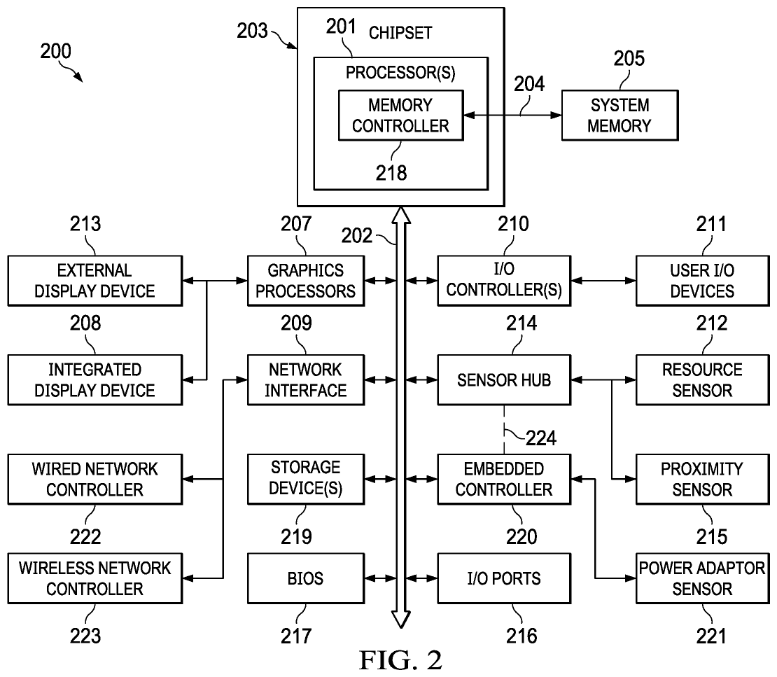

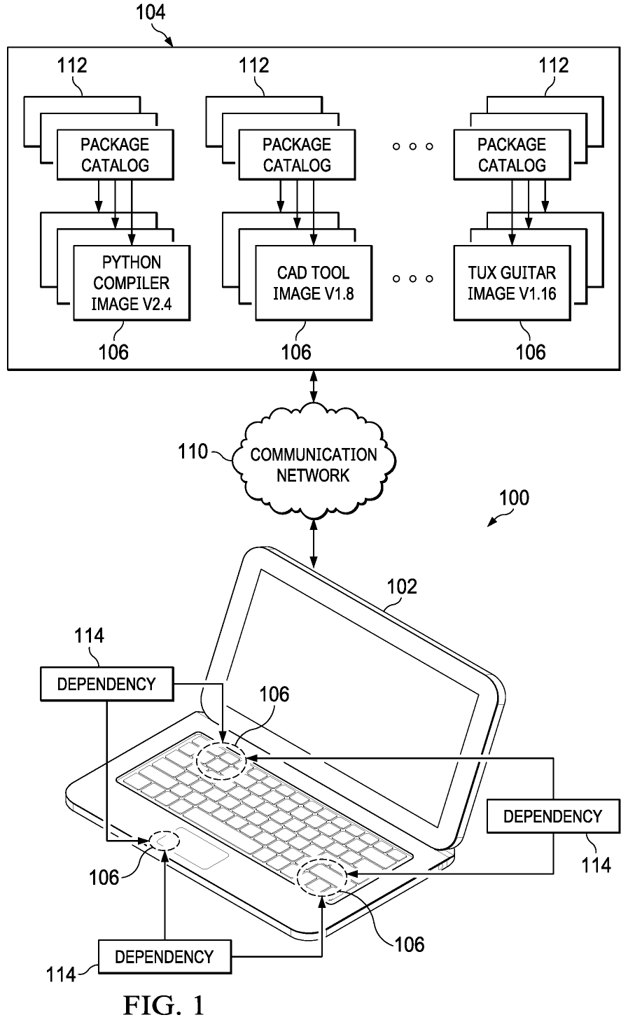

FIG. 1 illustrates an example software update verification system 100 according to one embodiment of the present disclosure. The software update verification system 100 includes a client IHS 102 in communication with a server IHS 104 that serves software packages 106 for upgrading on the client IHS 102 via a communication network 110, such as the Internet. Server IHS 104 is provided with a package catalog 112 for each version of software package 106 that includes information about its dependencies 114 on the configuration characteristics of other software packages 106 configured in the client IHS 102. As will be described in detail herein below, when client IHS 102 requests to download a software package 106 for upgrading one of its resources, the package catalog 112 may be accessed to determine any dependencies 114 to other software packages 106 that may exist, and if so, resolve those dependencies 114 so that the software package 106, when installed or otherwise updated on the client IHS 102, may function properly.

Software packages 106 often incur dependencies 114 due in large part, to their ongoing publication throughout the serviceable lifespan of the client IHS 102. In many cases, this is due to ongoing software upgrades of other software packages that may, or may not be, compatible with the current software package 106 to be downloaded and installed on the client IHS 102. For example, a software package 106, such as a driver to a hardware component of the client IHS 102, for a certain resource of the client IHS 102 may include features and processes that are not compatible with the current version of software packages 106 currently implemented on the client IHS 102. Additionally, the current software packages 106 implemented on the client IHS 102 may have certain configuration settings that cause these software packages 106 to be incompatible with the software package 106 to be upgraded. This problem is further exacerbated by the fact that it is difficult, if not impossible, to predict when or how these dependencies may emerge due to the recurring nature of how software package updates are promoted or made available by the provider of those software packages 106.

Accordingly, a package catalog 112 is provided for each version of software package 106 provided by server IHS 104 in which the package catalog 112 is populated with information known about certain dependencies 114 for its associated version of software package 106. Thus, when the client IHS 102 requests that particular version of software package 106, the package catalog 112 may be accessed to determine if any dependencies 114 exist, and if so, perform one or more resolution techniques to remedy those dependencies 114.

In general, the package catalog 112 includes one or more entries (e.g., artifacts) each indicating a dependency 114 to another software package 106, a configuration setting of a software package 106, or even a hardware resource of the client IHS 102. The package catalog 112 is updated when information about any new dependencies 114 become available. In one embodiment, the software update verification system 100 may provide a user interface for receiving user input representing dependency information used to populate the package catalog 112. In another embodiment, the software update verification system 100 may be configured to update the package catalog 112 with new entries as they are discovered. For example, when a new version of software package 106 is made available for users, a structured package catalog 112 may also be provided with entries configured in computer-readable, parsable format (e.g., type-length-value (TLV) format, etc.) so that the software update verification system 100 will be able to verify any known dependencies 114 prior to allowing its software package 106 to be installed on the client IHS 102.

Server IHS 104 may be any type that disseminates or otherwise provides online software packages 106 to be updated on client IHSs 102. For example, server IHS 104 may be administered by an IHS provider, such as the DELL CORPORATION, which is headquartered in Round Rock, Tex., which has an online support portal for distributing software packages 106 to its customer base.

In one embodiment, server IHS 104 may be one that is administered by an organization, such as a corporation, school, or other enterprise that may supply client IHSs 102 to some, most, or all of its members or customers. Embodiments of the present disclosure implemented for use with such organizations may be particularly beneficial in that the client IHSs 102 provided to its members are typically configured with known sets of resources (e.g., hardware components, software packages, peripheral components, etc.) over which the administrators may have direct or at least indirect control such that dependencies 114 between those resources may be readily assessed and remedied as they occur. For example, the DELL CORPORATION provides certain classes of premier, high-quality client IHSs 102 to users, such as via their LATITUDE and PRECISION product lines that are often included with certain established well-known resources. As such, software package upgrades to these resources can be managed at a level where dependencies 114 between those software packages can be resolved to a relatively good degree.

The server IHS 104 and client IHS 102 communicate with one another in any suitable communication network 110. For example, the server IHS 104 and client IHS 102 communicate with each other using wireless and/or wireline communications. In one embodiment, the server IHS 104 and client IHS 102 communicate with one another using a communication network, such as the Internet, an intranet, or another wired and/or wireless communication network. In one aspect, the server IHS 104 and client IHS 102 communicate with one another using any suitable protocol or messaging scheme. For example, they may communicate using a Hypertext Transfer Protocol (HTTP), extensible markup language (XML), extensible hypertext markup language (XHTML), or a Wireless Application Protocol (WAP) protocol. Other examples of communication protocols exist. For example, the server IHS 104 and client IHS 102 may communicate with one another without the use of a separate and a distinct network, such as one where the server IHS 104 and client IHS 102 are integrated in one computing system.

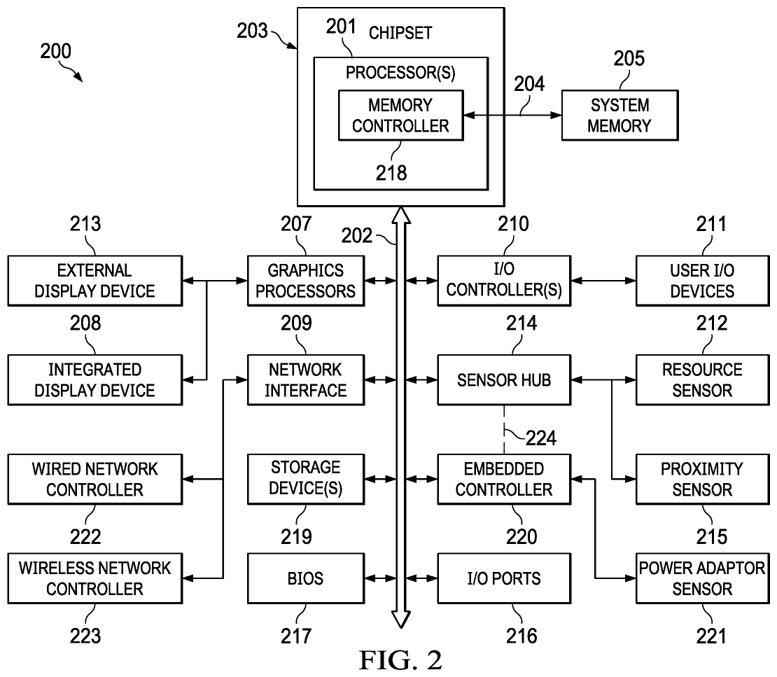

FIG. 2 is a block diagram illustrating components of example IHS 200 configured to manage a communication link with a wireless docking station according to one embodiment of the present disclosure. IHS 200 may be implemented in whole, or as a part of client IHS 102, or server IHS 104. As shown, IHS 200 includes one or more processors 201, such as a Central Processing Unit (CPU), that execute code retrieved from system memory 205. Although IHS 200 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 200 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), and/or NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 200 utilizes chipset 203 that may include one or more integrated circuits that are coupled to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 200, bus 202 is illustrated as a single element. Various embodiments may utilize any number of separate buses to provide the illustrated pathways served by bus 202.

In various embodiments, IHS 200 may include one or more I/O ports 216 that may support removable couplings with various types of external devices and systems, including removable couplings with peripheral devices that may be configured for operation by a particular user of IHS 200. For instance, I/O ports 216 may include USB (Universal Serial Bus) ports, by which a variety of external devices may be coupled to IHS 200. In addition to or instead of USB ports, I/O ports 216 may include various types of physical I/O ports that are accessible to a user via the enclosure of the IHS 200.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 200 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 200. User I/O devices 211 may interface with an I/O controller 210 through wired or wireless couplings supported by IHS 200. In some cases, I/O controllers 210 may support configurable operation of supported peripheral devices, such as user I/O devices 211.

As illustrated, a variety of additional resources may be coupled to the processor(s) 201 of the IHS 200 through the chipset 203. For instance, chipset 203 may be coupled to network interface 209 that may support different types of network connectivity. IHS 200 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support different types of network connectivity, such as the network connectivity utilized by IHS 200.

Chipset 203 may also provide access to one or more display device(s) 208 and 213 via graphics processor 207. Graphics processor 207 may be included within a video card, graphics card or within an embedded controller installed within IHS 200. Additionally, or alternatively, graphics processor 207 may be integrated within processor 201, such as a component of a system-on-chip (SoC). Graphics processor 207 may generate display information and provide the generated information to one or more display device(s) 208 and 213, coupled to IHS 200.

One or more display devices 208 and 213 coupled to IHS 200 may utilize LCD, LED, OLED, or other display technologies. Each display device 208 and 213 may be capable of receiving touch inputs such as via a touch controller that may be an embedded component of the display device 208 and 213 or graphics processor 207, or it may be a separate component of IHS 200 accessed via bus 202. In some cases, power to graphics processor 207, integrated display device 208 and/or external display device 213 may be turned off, or configured to operate at minimal power levels, in response to IHS 200 entering a low-power state (e.g., standby).

As illustrated, IHS 200 may support an integrated display device 208, such as a display integrated into a laptop, tablet, 2-in-1 convertible device, or mobile device. IHS 200 may also support use of one or more external display devices 213, such as external monitors that may be coupled to IHS 200 via various types of couplings, such as by connecting a cable from the external display device 213 to external I/O port 216 of the IHS 200. In certain scenarios, the operation of integrated display devices 208 and external display devices 213 may be configured for a particular user. For instance, a particular user may prefer specific brightness settings that may vary the display brightness based on time of day and ambient lighting conditions.

Chipset 203 also provides processor 201 with access to one or more storage devices 219. In various embodiments, storage device 219 may be integral to IHS 200 or may be external to IHS 200. In certain embodiments, storage device 219 may be accessed via a storage controller that may be an integrated component of the storage device. Storage device 219 may be implemented using any memory technology allowing IHS 200 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 200 also includes a Basic Input/Output System (BIOS) 217 that may be stored in a non-volatile memory accessible by chipset 203 via bus 202. Upon powering on or restarting IHS 200, processor(s) 201 may utilize BIOS 217 instructions to initialize and test hardware components coupled to the IHS 200. BIOS 217 instructions may also load an operating system (OS) (e.g., WINDOWS, MACOS, iOS, ANDROID, LINUX, etc.) for use by IHS 200.

BIOS 217 provides an abstraction layer that allows the operating system to interface with the hardware components of the IHS 200. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 200 embodiments may utilize sensor hub 214 capable of sampling and/or collecting data from a variety of sensors. For instance, sensor hub 214 may utilize hardware resource sensor(s) 212, which may include electrical current or voltage sensors, that are capable of determining the power consumption of various components of IHS 200 (e.g., CPU 201, GPU 207, system memory 205, etc.). In certain embodiments, sensor hub 214 may also include capabilities for determining a location and movement of IHS 200 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user's presence near IHS 200, absence from IHS 200, and/or distance from IHS 200 (e.g., near-field, mid-field, or far-field).

In certain embodiments, sensor hub 214 may be an independent microcontroller or other logic unit that is coupled to the motherboard of IHS 200. Sensor hub 214 may be a component of an integrated system-on-chip incorporated into processor 201, and it may communicate with chipset 203 via a bus connection such as an Inter-Integrated Circuit (I²C) bus or other suitable type of bus connection. Sensor hub 214 may also utilize an I²C bus for communicating with various sensors supported by IHS 200.

As illustrated, IHS 200 may utilize embedded controller (EC) 220, which may be a motherboard component of IHS 200 and may include one or more logic units. In certain embodiments, EC 220 may operate from a separate power plane from the main processors 201 and thus the OS operations of IHS 200. Firmware instructions utilized by EC 220 may be used to operate a secure execution system that may include operations for providing various core functions of IHS 200, such as power management, management of operating modes in which IHS 200 may be physically configured and support for certain integrated I/O functions.

EC 220 may also implement operations for interfacing with power adapter sensor 221 in managing power for IHS 200. These operations may be utilized to determine the power status of IHS 200, such as whether IHS 200 is operating from battery power or is plugged into an AC power source (e.g., whether the IHS is operating in AC-only mode, DC-only mode, or AC+DC mode). In some embodiments, EC 220 and sensor hub 214 may communicate via an out-of-band signaling pathway or bus 224.

In various embodiments, IHS 200 may not include each of the components shown in FIG. 2. Additionally, or alternatively, IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

Referring now in more detail to FIG. 3, a block diagram illustrating several components of the server IHS 104, is depicted according to one aspect of the present disclosure. The modules and components as shown are stored in a memory 304 (e.g., computer readable media) and executed on a processing system 302 of the server IHS 104. The server IHS 104 may include any type of computing system, such as one or more management computing systems, personal computers, mobile computers and/or other mobile devices, and other hosts. Additionally, the processing system 302 includes one or more processors that execute instructions of the modules and components described herein below.

The memory 304 may include volatile media, nonvolatile media, removable media, non-removable media, and/or another available medium. By way of example and not limitation, memory 304 comprises computer storage media, such as non-transient storage memory, volatile media, nonvolatile media, removable media, and/or non-removable media implemented in a method or technology for storage of information, such as computer readable instructions, data structures, program modules, or other data.

According to one aspect, the operations management server IHS 104 may also include a user interface (e.g., a graphical user interface (GUI) or a command line interface (CLI)) displayed on a display, such as a computer monitor, for displaying data. The server IHS 104 also includes an input device, such as a keyboard or a pointing device (e.g., a mouse, trackball, pen, or touch screen) to enter data into or interact with the user interface module 306. According to one aspect, the system 100 may include instructions or modules that are executable by the processing system 302 as will be described in detail herein below.

A user interface module 306 facilitates the receipt of input data and/or output data from or to a user, respectively. For example, the user interface module 306 may generate a user interface for receiving user input, such as to receive user information associated with a dependency 114, such as one that was discovered by the user in support of client IHSs 102 in the field. As another example, the user interface module 306 may also receive user input for manipulating or otherwise modifying the operation of the software update verification system. The user interface module 306 may also display one or more selectable fields, editing screens, and the like for receiving the user input from the user.

A package catalog management module 308 is used to manage the creation and upgrading of the package catalog 112. For example, when a new dependency 114 is discovered by a user, the package catalog management module 308 may, using the user interface module 306, receive user input for updating a package catalog associated with the affected software package to include an entry indicative of that newly discovered dependency 114. In some embodiments, the package catalog management module 308 may include an application program interface (API) to receive dependency information from another process running on the server IHS 104 for updating the package catalog 112.

A client IHS discovery module 310 performs a discovery process to obtain configuration information about the client IHS 102. For example, when a new software package 106 is to be installed on the client IHS 102, the client IHS discovery module 310 may obtain configuration characteristics about each software package 106 installed on the client IHS 102, a type of hardware configuration along with configuration characteristics of the OS of the client IHS 102. In many currently produced IHSs, its BIOS 1xx often includes a SMBIOS interface that can be used to read management information it produces. This feature can eliminate the need for the operating system to probe hardware directly to discover what devices are present in the computer. As such, the client IHS discovery module 310 may access the SMBIOS to obtain certain configuration characteristics of the client IHS 102. Additionally, the client IHS discovery module 310 may access an OS registry or other similar tool, such as the Windows registry provided by the Microsoft Corporation, to access software package information from the client IHS 102.

A software package deployment module 312 manages the installation of new software packages 106 on the client IHS 102. For example, when a request is received to update an existing software package 106 or install a new software package 106, the software package deployment module 312 may use the client IHS discovery module 310 to obtain configuration characteristics of the client IHS 102, and compare the obtained configuration characteristics against any dependency information stored in the package catalog 112 to determine whether or not any dependencies need to be resolved prior to installing the software package 106. In some cases, the software package deployment module 312 may automatically resolve any dependencies, such as by updating any dependent software packages, changing any necessary configuration settings of the any of the software packages including those of the operation system of the client IHS 102. In other cases, the software package deployment module 312 may use the interface module 306 to display dependency information to the user so that the user can resolve any dependencies manually.

It should be appreciated that the modules described herein are provided only as examples, and that the server IHS 104 may have different modules, additional modules, or fewer modules than those described herein. For example, one or more modules as described in FIG. 3 may be combined into a single module. As another example, certain modules described herein may be encoded on, and executed on other computing systems, such as on the client IHS 102. As yet another example, although the package catalog management module 308 and software package deployment module 312 are stored in, and executed by the server IHS 104; in other embodiments, either of the package catalog management module 308 and/or software package deployment module 312 may be stored in, and executed by the client IHS 102.

FIG. 4 illustrates a package catalog updating method 400 depicting how the package catalog 112 of each software package 106 may be updated according to one embodiment of the present disclosure. In one embodiment, the package catalog updating method 400 may be performed in whole, or in part, by package catalog management module 308 described herein above. Initially, a new software package 106 or a new version of an existing software package 106 is promoted or made available by a provider of the software package and/or the hardware resource that the software package 106 supports. Additionally, when the new software package 106 or new version of an existing software package 106 is made available, a package catalog 112 is instantiated for use with the package catalog updating method 400.

At step 402, the package catalog updating method 400 receives information associated with a dependency of the software package 106 to a particular configuration characteristic of the client IHS 102. In one embodiment, the dependency information may be in computer-readable form such that the package catalog updating method 400 may receive and process the dependency information from another executable process. In another embodiment, the package catalog updating method 400 may receive the dependency information via user input.

At step 404, the package catalog updating method 400 accesses the package catalog 112 associated with the affected software package 106, and parses the package catalog 112 at step 406. Thereafter at step 408, the method 400 parses the received dependency information.

At step 410, the package catalog updating method 400 determines whether or not other software packages 106 are affected by the dependency. For example, the dependency may require that a particular configuration setting of the OS be a certain value, and that value may not be allowed by another software package 106 currently installed on the client IHS 102. In such a case, the package catalog updating method 400 may update the package catalog 112 of that other affected software package 106 to reflect the fact that a broken dependency or co-dependency exists between it and the subject software package 106. To check for such cases, the package catalog updating method 400 may scan the other package catalogs 112 existent in the system to determine whether they include a dependency that includes that particular configuration setting. Nevertheless, if other software packages 106 are affected by the dependency, processing continues at step 412 to update the package catalogs 112 associated with the other software packages 106 to indicate the dependency; otherwise, processing continues at step 414. Thereafter at step 414, the package catalog updating method 400 appends the dependency information to the package catalog 112 associated with the subject software package 106.

The aforedescribed method 400 may be performed each time a dependency is identified. Nevertheless, when use of the package catalog updating method 400 is no longer needed or desired, the method 400 ends.

FIG. 5 illustrates a software package deployment method 500 depicting how a software package 106 may be deployed or installed on the client IHS 102 according to one embodiment of the present disclosure. In one embodiment, the software package deployment method 500 may be performed in whole, or in part, by the IHS 104 using the software package deployment module 312 described herein above. Initially, a package catalog 112 has been instantiated using certain techniques, such as described above with reference to FIG. 4.

At step 502, the software package deployment method 500 receives a request to deploy a software package 106, obtains the package catalog 112 with which it is associated at step 504, and parses the package catalog 112 at step 506. Thereafter at step 508, the software package deployment method 500 determines whether or not any dependencies exist for the software package 106. For example, the software package deployment method 500 may, by accessing the package catalog 112, identify one or more configuration characteristics of the client IHS 102 that the software package depends upon to operate on the client IHS 102, and obtain configuration information from the client IHS 102. In one embodiment, the software package deployment method 500 may obtain configuration information from the client IHS 102 by performing a discovery process to identify those resources that exist, version of software packages 106 that accompany those resources, and any particular configuration settings that the software packages 106 may be set to. In a particular embodiment, the software package deployment method 500 may access the OS registry of the client IHS 102, the SMBIOS interface of the BIOS, or other mechanism of the client IHS 102 to identify such information.

If the software package deployment method 500 is performed by a process (e.g., software package deployment module 312) executed by the server IHS 104, for example, it may access certain suitable IHS configuration access mechanisms, such as the OS registry and/or SMBIOS using a cloud communication architecture. If, however, the software package deployment method 500 is performed by a process executed by the client IHS 102, it may access those IHS configuration access mechanisms locally. Additionally, if the software package deployment method 500 is performed by the client IHS 102, the package catalog 112 may be downloaded for use by the software package deployment method 500 when the candidate software package 106 is downloaded.

If at step 508 determines that any dependencies exist, processing continues at step 510; otherwise, processing continues at step 516 in which the software package 106 is deployed on the client IHS 102.

At step 510, the software package deployment method 500 determines, via user input, whether or not the user desires to use manual intervention to resolve the dependency or have the software package deployment method 500 automatically attempt to resolve the dependency. If the software package deployment method 500 receives user input indicating that manual resolution of the dependencies are desired, processing ends at step 518; otherwise, processing continues at step 512.

At step 512, the software package deployment method 500 identifies the configuration characteristics associated with the dependencies by, for example, accessing the package catalog 112 that was used earlier to determine those dependencies that exist. Thereafter at step 514, the software package deployment method 500 attempts to resolve the dependencies. For example, the software package deployment method 500 may communicate with certain other software packages 106 in the client IHS 102 to change one or more of its configuration settings. As another example, the software package deployment method 500 may attempt to download and install any other software packages 106, such as an update to another updatable component of the client IHS 102 that are needed by the subject software package 106.

At step 516, the software package deployment method 500 determines whether the dependency resolution attempts previously performed were successful. If so, processing continues at step 518 to install (deploy) the software package 106; otherwise, the process is halted at step 520. In one embodiment, the software package deployment method 500 may display an indication, such as via a pop-up window on the screen of the client IHS 102 indicating whether or not the dependency resolution attempt was successful or not.

The software package deployment method 500 described above may be repeated each time another software package 106 is requested to be installed on the client IHS 102. Nevertheless, when use of the software package deployment method 500 is no longer needed or desired, the method 500 ends.

Although FIGS. 4 and 5 each describe one example of a process that may be performed to validate or otherwise verify software package integrity prior to installation, the features of the disclosed processes may be embodied in other specific forms without deviating from the spirit and scope of the present disclosure. For example, certainly steps of the disclosed processes may be performed sequentially, or alternatively, they may be performed concurrently. As another example, the methods 400 and 500 may perform additional, fewer, or different operations than those operations as described in the present example. As yet another example, the steps of the processes described herein may be performed by a computing system other than client IHS 102 or server IHS 104, such as by another cloud service existing in the cloud network that communicates with client IHS 102 and server IHS 104.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A software upgrade verification system comprising:
at least one processor; and
at least one memory coupled to the at least one processor, the at least one memory having program instructions stored thereon that, upon execution by the at least one processor, cause the instructions to:
identify, by a server Information Handling System (IHS), a configuration characteristic of at least one software package dependency, the software package dependency comprising a resource of a client IHS that a software package depends upon to operate on the client IHS;
update, by the server IHS, a data structure to indicate the identified software package dependency to the configuration characteristic; and
when the client IHS requests to be upgraded with the software package:
access, by the client IHS, the data structure to determine whether or not the configuration characteristic currently existing on the client IHS meets the identified software package dependency;
when the configuration characteristic meets the identified software package dependency, allow, by the client IHS, upgrading of the software package on the client IHS; and
when the configuration characteristic does not meet the identified software package dependency, inhibit, by the client IHS, upgrading of the software package on the client IHS.

2. The software upgrade verification system of claim 1, wherein the data structure comprises a file that is associated with the software package.

3. The software upgrade verification system of claim 1, wherein the instructions are further executed to:
obtain, by the client IHS, the software package from the server IHS; and
obtain the data structure from the server IHS when the software package is obtained from the server IHS.

4. The software upgrade verification system of claim 1, wherein:
the acts of accessing the data structure and either allowing or inhibiting upgrading of the software package are performed by the server IHS; and
the instructions are further executed to identify the configuration characteristic by receiving the configuration characteristic from the client IHS, the data structure being stored in the server IHS.

5. The software upgrade verification system of claim 1, wherein the instructions are further executed to receive the software package dependency in computer-readable form, and update the data structure using the received software package dependency.

6. The software upgrade verification system of claim 1, wherein the instructions are further executed to receive the software package dependency via user input, and update the data structure using the received software package dependency.

7. The software upgrade verification system of claim 1, wherein the configuration characteristic comprises at least one of a different software package, a hardware resource of the client IHS, a configuration setting of the client IHS, and a configuration setting of the different software package.

8. The software upgrade verification system of claim 1, wherein the instructions are further executed to, when the configuration characteristic does not meet the identified software package dependency, resolve the dependency by at least one of upgrading another software package on the client IHS that causes the unmet dependency or changing a configuration setting that causes the unmet dependency.

9. The software upgrade verification system of claim 8, wherein the instructions are further executed to, when the configuration characteristic does not meet the identified software package dependency and prior to resolving the dependency, receive user input for obtaining permission to resolve the dependency.

10. The software upgrade verification system of claim 1, wherein the instructions are further executed to, when the configuration characteristic does not meet the identified software package dependency, issue a notification of the identified software package dependency to a user interface of the client IHS.

11. A method comprising:
identifying, by a server Information Handling System (IHS), a configuration characteristic of at least one software package dependency, the software package dependency comprising a resource of a client IHS that a software package depends upon to operate on the client IHS;
updating, by the server IHS, a data structure to indicate the identified software package dependency to the configuration characteristic;
when the client IHS requests to be upgraded with the software package:
accessing, by a client IHS, the data structure to determine whether or not the configuration characteristic meets the identified software package dependency;
when the configuration characteristic meets the identified software package dependency, allowing, by the client IHS, upgrading of the software package on the client IHS; and
when the configuration characteristic does not meet the identified software package dependency, inhibiting, by the client IHS, upgrading of the software package on the client IHS.

12. The method of claim 11, further comprising:
obtaining, by the client IHS, the software package from a server IHS; and
obtaining the data structure from the server IHS when the software package is obtained from the server IHS.

13. The method of claim 11, wherein:
obtaining, by the client IHS, the software package from the server IHS, wherein the steps of accessing the data structure and either allowing or inhibiting upgrading of the software package are performed by the server IHS; and
identifying the configuration characteristic by receiving the configuration characteristic from the client IHS, the data structure being stored in the server IHS.

14. The method of claim 11, further comprising receiving the software package dependency in computer-readable form, and updating the data structure using the received software package dependency.

15. The method of claim 11, further comprising receiving the software package dependency via user input, and updating the data structure using the received software package dependency.

16. The method of claim 11, further comprising, when the configuration characteristic does not meet the identified software package dependency, resolving the dependency by at least one of upgrading another software package on the client IHS that causes the unmet dependency or changing a configuration setting that causes the unmet dependency.

17. The method of claim 16, further comprising, when the configuration characteristic does not meet the identified software package dependency and prior to resolving the dependency, receiving user input for obtaining permission to resolve the dependency.

18. The method of claim 11, further comprising, when the configuration characteristic does not meet the identified software package dependency, issuing a notification of the identified software package dependency to a user interface of the client IHS.

19. A memory storage device having program instructions stored thereon that, upon execution by one or more processors of an Information Handling System (IHS), cause the IHS to:
identify, by a server IHS, a configuration characteristic of at least one software package dependency, the software package dependency comprising a resource of the client IHS that a software package depends upon to operate on the client IHS;
update, by the server IHS, a data structure to indicate the identified software package dependency to the configuration characteristic;
when the client IHS requests to be upgraded with the software package:
access, by the client IHS, the data structure to determine whether or not the configuration characteristic meets the identified software package dependency;
when the configuration characteristic meets the identified software package dependency, allow, by the client IHS, upgrading of the software package on the client IHS; and
when the configuration characteristic does not meet the identified software package dependency, inhibit, by the client IHS, upgrading of the software package on the client IHS.

20. The memory storage device of claim 19, wherein the instructions are further executed to:
when the software package dependency is received in computer-readable form, update the data structure using the received software package dependency in computer-readable form; and
when the software package dependency is received via user input, convert the software package dependency to computer-readable form, and update the data structure using the converted software package dependency.
